(19) United States
(12) Patent Application Publication
(10) Pub. No.: US 2024/0319320 A1
(43) Pub. Date: Sep. 26, 2024

(54) WIRELESS COMMUNICATION AND SENSING METHOD AND DEVICE THEREOF

(71) Applicant: ZTE Corporation, Shenzhen (CN)

(72) Inventors: Yihua Ma, Shenzhen (CN); Zhifeng Yuan, Shenzhen (CN); Shuqiang Xia, Shenzhen (CN); Guanghui Yu, Shenzhen (CN); Liujun Hu, Shenzhen (CN)

(73) Assignee: ZTE Corporation, Shenzhen (CN)

(21) Appl. No.: 18/680,109

(22) Filed: May 31, 2024

Related U.S. Application Data
(63) Continuation of application No. PCT/CN2022/084817, filed on Apr. 1, 2022.

(51) Int. Cl. G01S 7/00; G01S 13/00; G01S 13/86; H04L 27/26

(52) U.S. Cl. CPC G01S 7/006; G01S 13/003; G01S 13/86; H04L 27/2605

(57) ABSTRACT

A wireless communication and sensing method is disclosed. The method comprises sending, by a wireless communication and sensing node, an integrated sensing and communication, ISAC, signal comprising a communication signal and a sensing signal, wherein the sensing signal comprises one or more single-tone signals, and wherein the number of the single-tone signals being less than 10.

### CROSS-REFERENCE TO RELATED APPLICATION

This application is a continuation of PCT/CN2022/084817, filed on Apr. 1, 2022, titled “WIRELESS COMMUNICATION AND SENSING METHOD AND DEVICE THEREOF”, and published as WO 2023/184484 A1 on Oct. 5, 2023, the entirety of which is incorporated herein by reference.

### TECHNICAL FIELD

This document is directed generally to wireless communications, and in particular to integrated sensing and communication.

### BACKGROUND

Integrated sensing and communication (ISAC) is expected to provide enormous add-on values to the communication systems in the 6G era. One major challenge is how to allocate the limited spectrum resources to ensure the performance of both functions.

The sensing signal in existing ISAC schemes can be an OFDM (orthogonal frequency-division multiplexing) or an FMCW (frequency-modulated continuous-wave) signal. When an OFDM signal is used for sensing, it is possible to reuse the communications signal to avoid sensing overheads. However, it requires complex full-duplex hardware to cancel self-interference and the sensing beam can be different from the communications beam. When an FMCW signal is used for sensing, the self-interference cancellation hardware can be simple. However, FMCW requires a lot of time-frequency resources to ensure the performance.

### SUMMARY

This document relates to methods, systems, and devices for the ISAC, and more particularly to methods, systems, and devices for transmitting, and/or receiving the ISAC signal.

The present disclosure relates to a wireless communication and sensing method. The method comprises:
sending, by a wireless communication and sensing node, an integrated sensing and communication, ISAC, signal comprising a communication signal and a sensing signal, wherein the sensing signal comprises one or more single-tone signals, and wherein the number of the single-tone signals being less than 10.

Various embodiments may preferably implement the following features:

Preferably, the sensing signal consists of one single-tone signal.

Preferably, the time spacing between the first and last time-domain position of the one or more single-tone signals is larger than 90% of a total time duration of the ISAC signal.

Preferably, the one or more single-tone signals have a duty cycle within 0% and 100%.

Preferably, the one or more single-tone signals are periodic or non-periodic.

Preferably, the one or more single-tone signals are continuous or discontinuous.

Preferably, the ISAC signal comprises one or more guard bands between the one or more single-tone signals and the communication signal.

Preferably, the ISAC signal is carried on a plurality of sub-carriers, and one of the one or more single-tone signals is carried on one of the sub-carriers with the highest or lowest frequency band.

Preferably, the sensing signal is used as a reference signal of the communications signal.

Preferably, the wireless communication and sensing method further comprises receiving, by the wireless communication and sensing node, the sensing signal in the ISAC signal sent by the wireless communication and sensing node.

Preferably, the wireless communication and sensing method further comprises determining, by the wireless communication and sensing node, sensing information based on the sensing signal.

Preferably, the one or more single-tone signals in difference periods have difference frequencies.

Preferably, the sensing signal in the ISAC signal is sent to another wireless communication and sensing node.

The present disclosure relates to another wireless communication and sensing method. The wireless communication and sensing method comprises:

receiving, by a wireless communication and sensing node, a sensing signal in an integrated sensing and communication, ISAC, signal, wherein the sensing signal comprises one or more single-tone signals, and wherein the number of the single-tone signals being less than 10.

Various embodiments may preferably implement the following features:

Preferably, the wireless communication and sensing method further comprises determining, by the wireless communication and sensing node, sensing information based on the sensing signal.

Preferably, the sensing signal consists of one single-tone signal.

Preferably, the time spacing between the first and last time-domain position of the one or more single-tone signals is larger than 90% of a total time duration of the ISAC signal.

Preferably, the one or more single-tone signals have a duty cycle within 0% and 100%.

Preferably, the one or more single-tone signals are periodic or non-periodic.

Preferably, the one or more single-tone signals are continuous or discontinuous.

Preferably, the ISAC signal comprises one or more guard bands between the one or more single-tone signals and a communication signal of the ISAC signal.

Preferably, the ISAC signal is carried on a plurality of sub-carriers, and one of the one or more single-tone signals is carried on one of the sub-carriers with the highest or lowest frequency band.

Preferably, the wireless communication and sensing method further comprises using the sensing signal as a reference signal of a communication signal of the ISAC signal.

Preferably, the one or more single-tone signals in different periods have difference frequencies.

Preferably, the sensing signal is received from another wireless communication and sensing node.

The present disclosure also relates to a wireless communication and sensing node. The wireless communication and sensing node comprises:
a communication unit, configured to send an integrated sensing and communication, ISAC, signal comprising a communication signal and a sensing signal, wherein the sensing signal comprises one or more single-tone signals, and wherein the number of the single-tone signals being less than 10.

Various embodiments may preferably implement the following feature:

Preferably, the wireless communication and sensing node further comprises a processor configured to perform any of the aforementioned wireless communication and sensing methods.

Various embodiments may preferably implement the following feature:

The present disclosure further relates to another wireless communication and sensing node. The wireless communication and sensing node comprises:

a communication unit, configured to receive a sensing signal in an integrated sensing and communication, ISAC, signal, wherein the sensing signal comprises one or more single-tone signals, and wherein the number of the single-tone signals being less than 10.

Preferably, the wireless communication and sensing node further comprises a processor configured to perform any of the aforementioned wireless communication and sensing methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIGS. 1, 2, 3, 4, 5, 6, and 7 show schematic diagrams of an ISAC signal according to embodiments of the present disclosure.

FIGS. 8, 9, and 10 show real parts of single-tone sensing signals in an ISAC signal in the time domain according to embodiments of the present disclosure.

FIG. 11 shows a monostatic sensing mode according to an embodiment of the present disclosure.

FIG. 12 shows a bistatic sensing mode according to an embodiment of the present disclosure.

FIG. 13 shows a monostatic plus bistatic sensing mode according to an embodiment of the present disclosure.

FIG. 14 shows a monostatic plus bistatic sensing mode according to an embodiment of the present disclosure.

FIG. 15 shows an example of a schematic diagram of a wireless terminal according to an embodiment of the present disclosure.

FIG. 16 shows an example of a schematic diagram of a wireless network node according to an embodiment of the present disclosure.

FIGS. 17 and 18 show flowcharts of methods according to some embodiments of the present disclosure.

### DETAILED DESCRIPTION

In order to overcome the above problems, the present disclosure proposes allocating only one or several sub-carriers to the sensing functions and recovering the target information with some prior knowledge.

In an embodiment, a sensing (achieved) via single-tone signal is also named continuous-wave radar or Doppler radar.

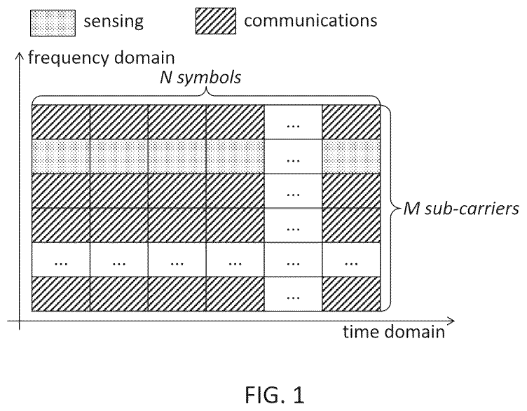

FIG. 1 shows an ISAC signal in the time-frequency domain according to an embodiment. There are in total M sub-carriers in the frequency domain and N symbols in the time domain, which also represents MN (i.e. M×N) resource elements (REs). Among all MN REs, the sensing signal only uses the m-th sub-carrier of all symbols, where 0≤m<M. In this embodiment, the sensing signal uses N REs, and the remaining REs are used for communications signal. The sensing part/signal in the ISAC signal is a single-tone signal. In an embodiment, the phases of the single-tone signal in different symbols can be continuous or discontinuous.

For the sensing function, one node (e.g. communication and sensing node or sensing node) transmits the ISAC signal, and the same or another node receives the sensing part/signal of the ISAC signal to extract/determine sensing information of a target from/based on the corresponding wireless channel/path of the sensing part/signal. For the communication function, one node transmits the ISAC signal, and another node receives the communications part/signal of the ISAC signal to extract/determine information (e.g. data) carried on communication part/signal of the ISAC signal. As the communication function also requires obtaining the channel information for demodulation, the sensing signal may also be used as a reference signal for the communications (e.g. the reference signal for the communication signal/part in the ISAC signal).

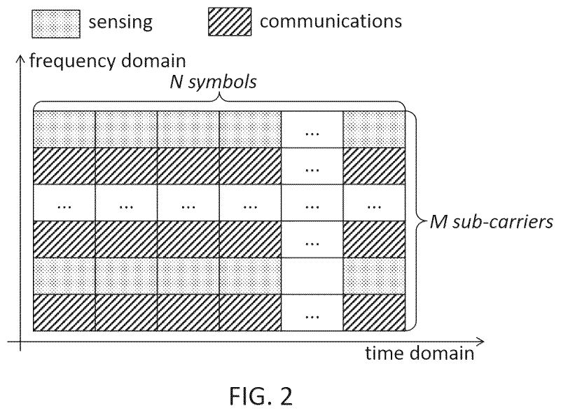

Another ISAC signal in the time-frequency domain according to an embodiment is shown in FIG. 2. There are in total M sub-carriers in the frequency domain and N symbols in the time domain, which also represents MN resource elements (REs). Among all MN REs, the sensing signal uses the m1-th and m2-th sub-carrier of all symbols, where 0≤m1<m2<M. In this embodiment, the sensing signal uses 2N REs, and the remaining REs are used for communication signal. The sensing part in the ISAC signal includes two single-tone signals. The phases of a single-tone signal in different symbols can be continuous or discontinuous.

For the sensing function, one node (e.g. communication and sensing node or sensing node) transmits the ISAC signal, and the same or another node receives the sensing part/signal of the ISAC signal to extract/determine sensing information of a target from/based on the corresponding wireless channel/path of the sensing part/signal. For the communication function, one node transmits the ISAC signal, and another node receives the communications part/signal of the ISAC signal to extract/determine information (e.g. data) carried on communication part/signal of the ISAC signal. As the communication function also requires obtaining the channel information for demodulation, the sensing signal may also be used as a reference signal for the communications.

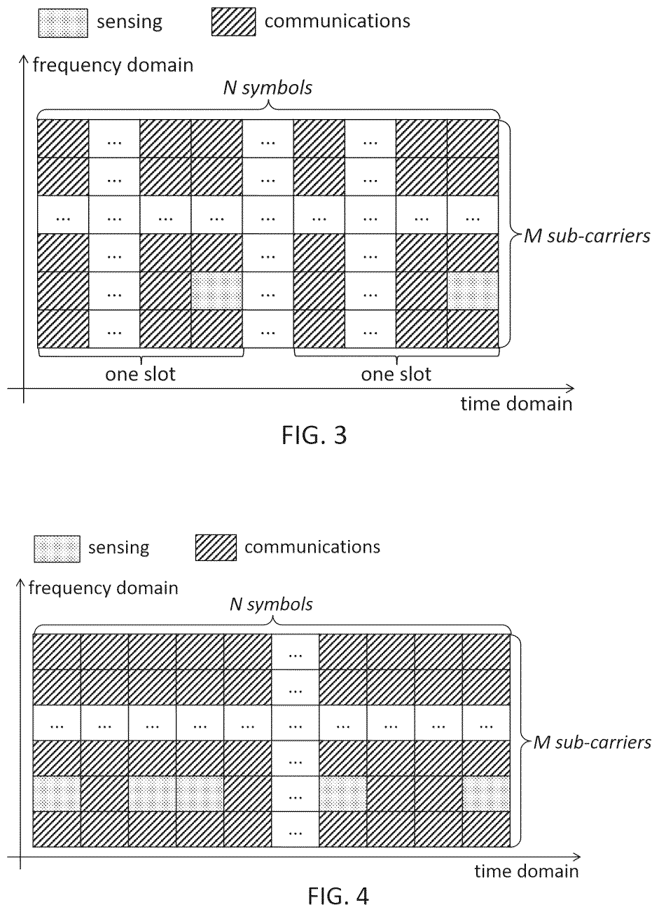

FIG. 3 shows another ISAC signal in the time-frequency domain according to an embodiment. There are in total M sub-carriers in the frequency domain and N symbols in the time domain, which also represents MN resource elements (REs). Among all MN REs, the sensing signal uses the m-th sub-carrier of the last symbols of all slot, where 0≤m<M. In this embodiment, the sensing signal uses Ns REs, and the remaining REs are used for communication signal. The sensing part in the ISAC signal is a single-tone signal. The wideband sensing signal can be FMCW, pulse signal, or low-correlation sequences. The phases of a single-tone signal in different symbols can be continuous or discontinuous.

For the sensing function, one node (e.g. communication and sensing node or sensing node) transmits the ISAC signal, and the same or another node receives the sensing part/signal of the ISAC signal to extract/determine sensing information of a target/object from/based on the corresponding wireless channel/path of the sensing part/signal. For the communication function, one node transmits the ISAC signal, and another node receives the communications part/signal of the ISAC signal to extract/determine information (e.g. data) carried on communication part/signal of the ISAC signal. As the communication function also requires obtaining the channel information for demodulation, the sensing signal may also be used as a reference signal for the communications.

FIG. 4 shows another ISAC signal in the time-frequency domain according to an embodiment. There are in total M sub-carriers in the frequency domain and N symbols in the time domain, which also represents MN resource elements (REs). Among all MN REs, the sensing signal uses the m-th sub-carrier of Nr symbols with non-periodic time positions where 0<m<M. In this embodiment, the sensing signal uses Nr REs, and the remaining REs are used for communications signal. The sensing part in the ISAC signal is a single-tone signal. The phases of a single-tone signal in different symbols can be continuous or discontinuous.

For the sensing function, one node (e.g. communication and sensing node or sensing node) transmits the ISAC signal, and the same or another node receives the sensing part/signal of the ISAC signal to extract/determine sensing information of a target from/based on the corresponding wireless channel/path of the sensing part/signal. For the communication function, one node transmits the ISAC signal, and another node receives the communications part/signal of the ISAC signal to extract/determine information (e.g. data) carried on communication part/signal of the ISAC signal. As the communication function also requires obtaining the channel information for demodulation, the sensing signal may also be used as a reference signal for the communications.

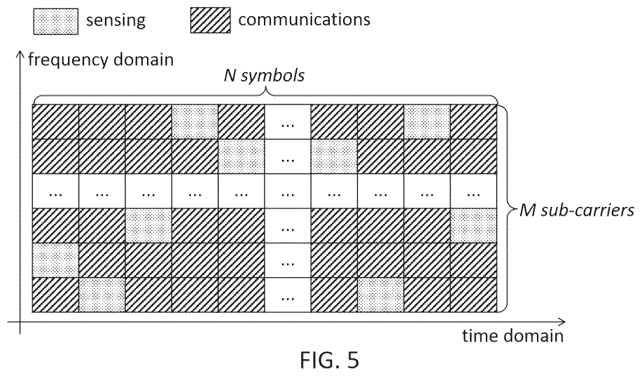

FIG. 5 shows another ISAC signal in the time-frequency domain according to an embodiment. There are in total M sub-carriers in the frequency domain and N symbols in the time domain, which also represents MN resource elements (REs). Among all MN REs, the sensing signal only uses the mi-th sub-carrier of all symbols, where 0≤mi<M. i is the index of symbol, and mi is not fixed for all symbols. In this embodiment, the sensing signal uses N REs, and the remaining REs are used for communications signal. The sensing part in the ISAC signal is a single-tone signal. The phases of a single-tone signal in different symbols can be continuous or discontinuous. Note that this kind of sensing signal is also used in the frequency-agile radar, but its coexistence with OFDM has not been revealed.

For the sensing function, one node (e.g. communication and sensing node or sensing node) transmits the ISAC signal, and the same or another node receives the sensing part/signal of the ISAC signal to extract/determine sensing information of a target from/based on the corresponding wireless channel/path of the sensing part/signal. For the communication function, one node transmits the ISAC signal, and another node receives the communications part/signal of the ISAC signal to extract/determine information (e.g. data) carried on communication part/signal of the ISAC signal. As the communication function also requires obtaining the channel information for demodulation, the sensing signal may also be used as a reference signal for the communications.

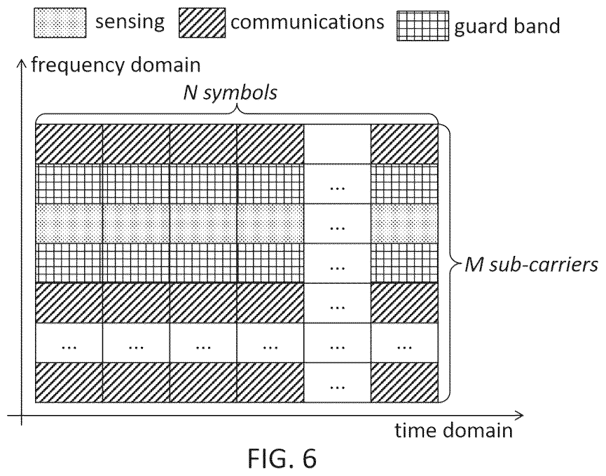

FIG. 6 shows another ISAC signal in the time-frequency domain according to an embodiment. There are in total M sub-carriers in the frequency domain and N symbols in the time domain, which also represents MN resource elements (REs). Among all MN REs, the sensing signal uses the m-th sub-carrier of all symbols, where 0<m<M. In this embodiment, there are guard bands between sensing signal and communications signal to avoid interference, and the guard band takes up one sub-carrier at both sides of the sensing signal in the frequency domain. The sensing signal uses N REs, and the remaining REs except guard bands are used for communications signal. The sensing part in the ISAC signal is a single-tone signal. The phases of a single-tone signal in different symbols can be continuous or discontinuous.

For the sensing function, one node (e.g. communication and sensing node or sensing node) transmits the ISAC signal, and the same or another node receives the sensing part/signal of the ISAC signal to extract/determine sensing information of a target from/based on the corresponding wireless channel/path of the sensing part/signal. For the communication function, one node transmits the ISAC signal, and another node receives the communications part/signal of the ISAC signal to extract/determine information (e.g. data) carried on communication part/signal of the ISAC signal. As the communication function also requires obtaining the channel information for demodulation, the sensing signal may also be used as a reference signal for the communications.

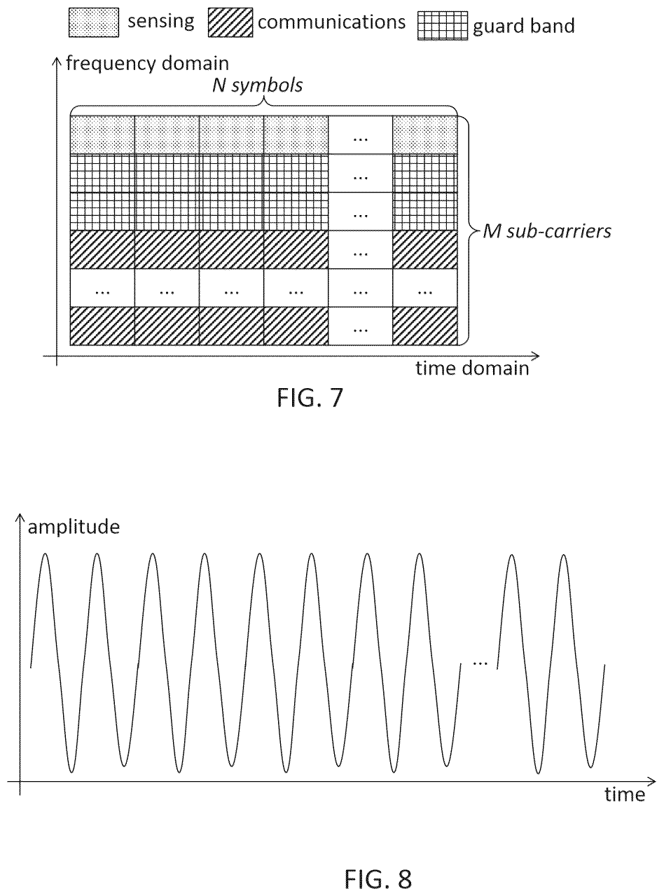

FIG. 7 shows another ISAC signal in the time-frequency domain according to an embodiment. There are in total M sub-carriers in the frequency domain and N symbols in the time domain, which also represents MN resource elements (REs). Among all MN REs, the sensing signal uses the sub-carrier with index 0 of all symbols. In this embodiment, there is a guard band between sensing signal and communications signal to avoid interference, and the guard band takes up two sub-carriers at one side of the sensing signal in the frequency domain. The guard band at another side already exists in the communications system to avoid the interference between different bands. Different from the embodiment shown in FIG. 6, the guard band also exists in the n-th symbol. The sensing signal uses N REs, and the remaining REs except the guard band are used for communications signal. The sensing part in the ISAC signal is a single-tone signal in the other symbols. The phases of a single-tone signal in different symbols can be continuous or discontinuous.

For the sensing function, one node (e.g. communication and sensing node or sensing node) transmits the ISAC signal, and the same or another node receives the sensing part/signal of the ISAC signal to extract/determine sensing information of a target from/based on the corresponding wireless channel/path of the sensing part/signal. For the communication function, one node transmits the ISAC signal, and another node receives the communications part/signal of the ISAC signal to extract/determine information (e.g. data) carried on communication part/signal of the ISAC signal. As the communication function also requires obtaining the channel information for demodulation, the sensing signal may also be used as a reference signal for the communications.

FIG. 8 describes the sensing part of an ISAC signal in the time domain according to an embodiment. As shown in the embodiments of FIGS. 1 to 7, the sensing signal is a single-tone signal or a superposition of several single-tone signals. As shown in FIG. 8, the phase of the single-tone signal is continuous. Note that the single-tone signal can be in the form of a complex number or a real number. When it is in the form of a complex number, FIG. 8 shows the real part, and the imaginary part can be easily obtained as a complex single-tone signal has a constant modulus. When they are in the form of a real number, FIG. 8 shows the real part, and there is no imaginary part.

FIG. 9 shows the sensing part of an ISAC signal in the time domain according to an embodiment. As shown in the embodiments of FIGS. 1 to 7, the sensing signal is a single-tone signal or a superposition of several single-tone signals. As shown in FIG. 9, the phase of the single-tone signal is discontinuous. Note that the single-tone signal can be in the form of a complex number or a real number. When it is in the form of a complex number, FIG. 9 shows the real part, and the imaginary part can be easily obtained as a complex single-tone signal has a constant modulus. When they are in the form of real number, FIG. 9 shows the real part, and there is no imaginary part.

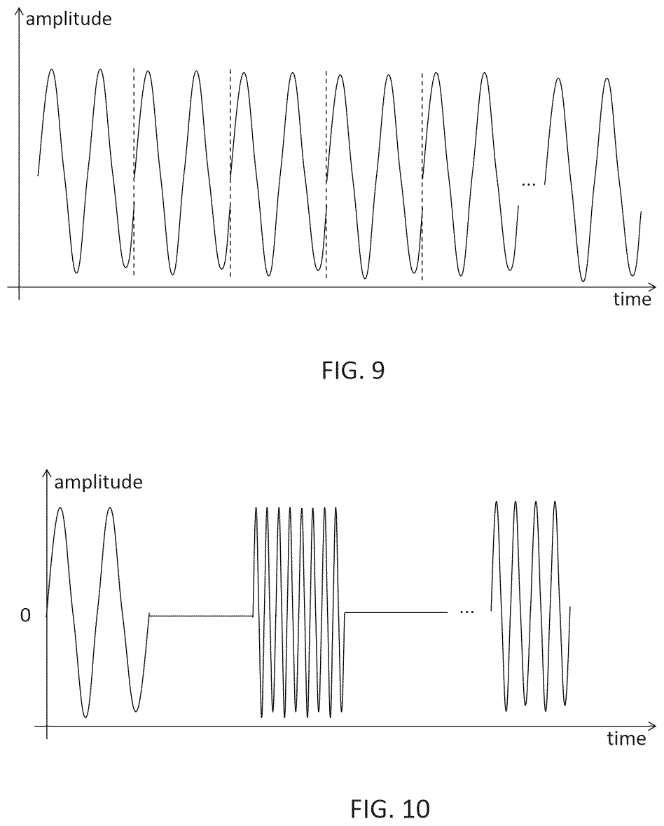

FIG. 10 describes the sensing part of an ISAC signal in the time domain according to an embodiment. As shown in the embodiments of FIGS. 1 to 7, the sensing signal is a single-tone signal or a superposition of several single-tone signals. As shown in FIG. 10, the frequency of the single-tone signal is not fixed, and the duty cycle is not 100%. Note that the single-tone signal can be in the form of a complex number or a real number. When it is in the form of complex number, FIG. 10 shows the real part, and the imaginary part can be easily obtained as a complex single-tone signal has a constant modulus. When they are in the form of real number, FIG. 10 shows the real part, and there is no imaginary part.

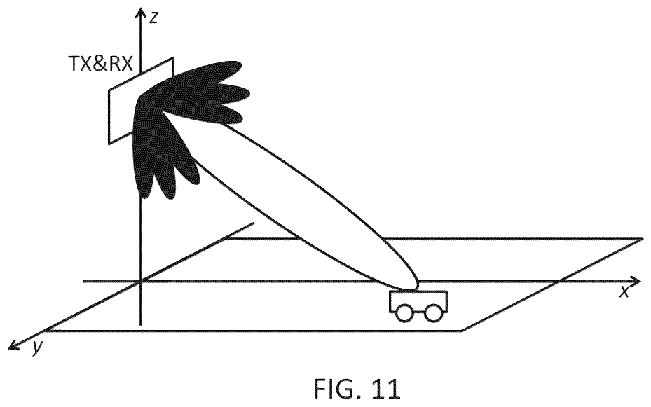

FIG. 11 shows a monostatic sensing mode according to an embodiment of the present disclosure. In the ISAC signal, the communications signal is transmitted from one node to another node, while the sensing signal can have different transmitting modes. This embodiment shows the monostatic sensing. As shown in FIG. 11, one node sends the ISAC signal and receives the echo of the sensing signal in the ISAC signal. Mono-static is a common radar mode.

As the sensing signal is based on the single-tone waveform, only the Doppler information can be obtained while the distance information cannot be directly obtained, which brings the challenge to locate the target position. However, the node has a 2D angle estimation, and the target position can be obtained if the target height is known, e.g., the target is on the ground. That is, in some scenarios like ground transportation detection, the target position can be obtained using the proposed single-tone sensing schemes. This embodiment can also be used in the intrusion detection scenarios to detect whether there is an intrusion.

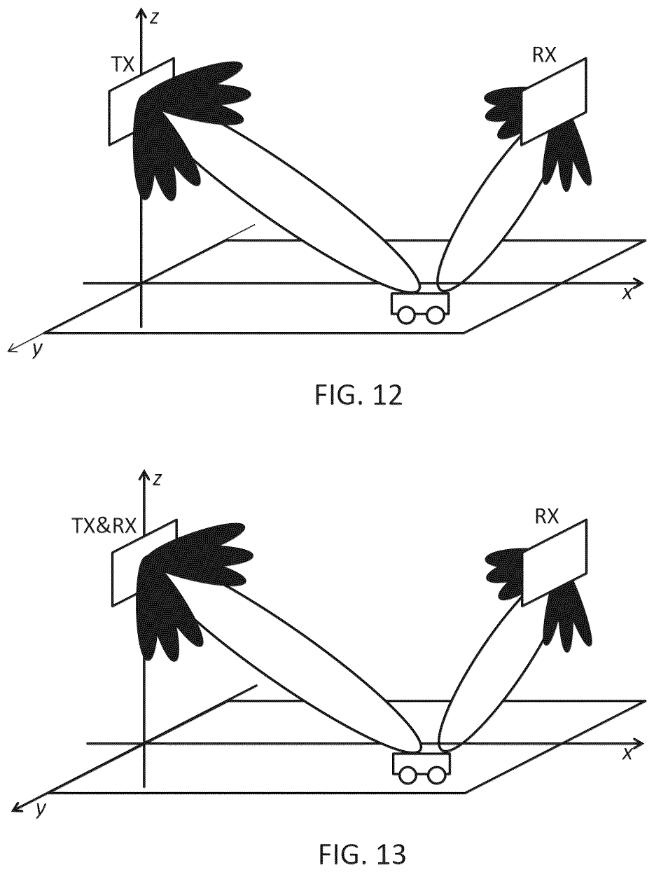

FIG. 12 shows a bistatic sensing mode according to an embodiment of the present disclosure. In the ISAC signal, the communications signal is transmitted from one node to another node, while the sensing signal can have different transmitting modes. This embodiment shows the bistatic and multi-static sensing. As shown in FIG. 12, one node sends the ISAC signal, and another node receives the echo of the sensing signal in the ISAC signal. This sensing mode is named bistatic. If there are more than one node receiving the echo of the sensing signal in the ISAC signal it is named multi-static. This disclosure only shows the bistatic mode as a non-limiting example since a multi-static mode can be seen as multiple pairs of bistatic sensing.

As the sensing signal is based on the single-tone waveform, only the Doppler information can be obtained while the distance information cannot be directly obtained, which brings the challenge to locate the target position. However, the node has a 2D angle estimation, and the target position can be obtained if the target height is known, e.g., the target is on the ground. That is to say, in some scenarios like ground transportation detection, the target position can be obtained using the proposed single-tone sensing schemes. This embodiment can also be used in the intrusion detection scenarios to detect whether there is an intrusion.

FIG. 13 shows a monostatic plus bistatic sensing mode according to an embodiment of the present disclosure. In the ISAC signal, the communications signal is transmitted from one node to another node, while the sensing signal can have different transmitting modes. This embodiment shows the monostatic plus bistatic sensing. As shown in FIG. 13, one node sends the ISAC signal, and this node and another node receive the echo of the sensing signal in the ISAC signal.

As the sensing signal is based on the single-tone waveform, only the Doppler information can be obtained while the distance information cannot be directly obtained, which brings the challenge to locate the target position. However, multiple nodes have a 2D angle estimation, and the target position can be obtained at the intersection point of directions obtained from the multiple node angle estimation. That is to say, in some scenarios like multiple cell sensing, the target position can be obtained using the proposed single-tone sensing schemes.

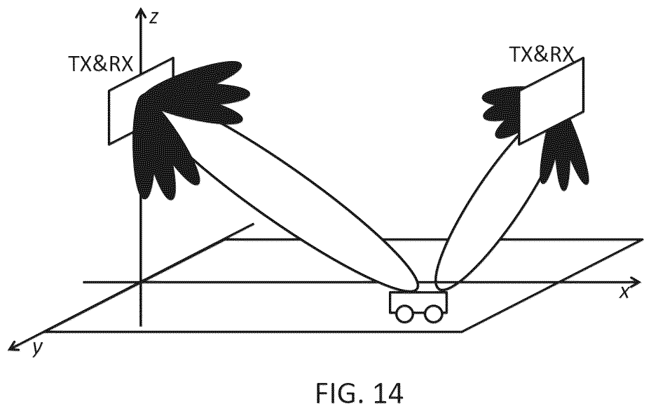

FIG. 14 shows a monostatic plus bistatic sensing mode according to an embodiment of the present disclosure. In the ISAC signal, the communications signal is transmitted from one node to another node, while the sensing signal can have different transmitting modes. This embodiment shows the multi-cell monostatic sensing. As shown in FIG. 14, one node sends the first ISAC signal and receives the echo of the first sensing signal in the ISAC signal, and another node sends the second ISAC signal and receives the echo of the sensing signal in the second ISAC signal. To avoid interference, the sensing signal of two ISAC signals can use different time-frequency positions.

As the sensing signal is based on the single-tone waveform, only the Doppler information can be obtained while the distance information cannot be directly obtained, which brings the challenge to locate the target position. However, multiple nodes have a 2D angle estimation, and the target position can be obtained at the intersection point of directions obtained from multiple node angle estimation. That is to say, in some scenarios like multiple cell sensing, the target position can be obtained using the proposed single-tone sensing schemes.

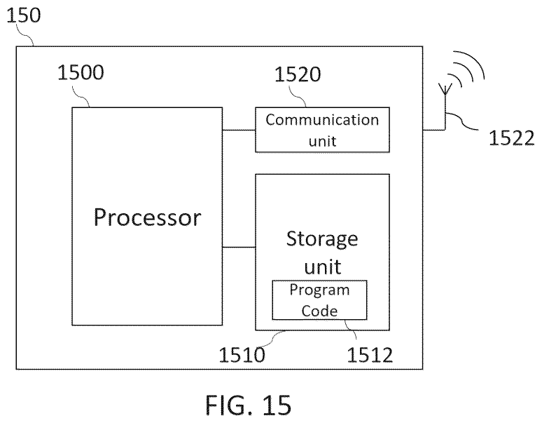

FIG. 15 relates to a schematic diagram of a wireless terminal 150 according to an embodiment of the present disclosure. The wireless terminal 150 may be a user equipment (UE), a mobile phone, a laptop, a tablet computer, an electronic book or a portable computer system and is not limited herein. The wireless terminal 150 may include a processor 1500 such as a microprocessor or Application Specific Integrated Circuit (ASIC), a storage unit 1510 and a communication unit 1520. The storage unit 1510 may be any data storage device that stores a program code 1512, which is accessed and executed by the processor 1500. Embodiments of the storage unit 1512 include but are not limited to a subscriber identity module (SIM), read-only memory (ROM), flash memory, random-access memory (RAM), hard-disk, and optical data storage device. The communication unit 1520 may a transceiver and is used to transmit and receive signals (e.g. messages or packets) according to processing results of the processor 1500. In an embodiment, the communication unit 1520 transmits and receives the signals via at least one antenna 1522 shown in FIG. 15.

In an embodiment, the storage unit 1510 and the program code 1512 may be omitted and the processor 1500 may include a storage unit with stored program code.

The processor 1500 may implement any one of the steps in exemplified embodiments on the wireless terminal 150, e.g., by executing the program code 1512.

The communication unit 1520 may be a transceiver. The communication unit 1520 may as an alternative or in addition be combining a transmitting unit and a receiving unit configured to transmit and to receive, respectively, signals to and from a wireless network node (e.g. a base station).

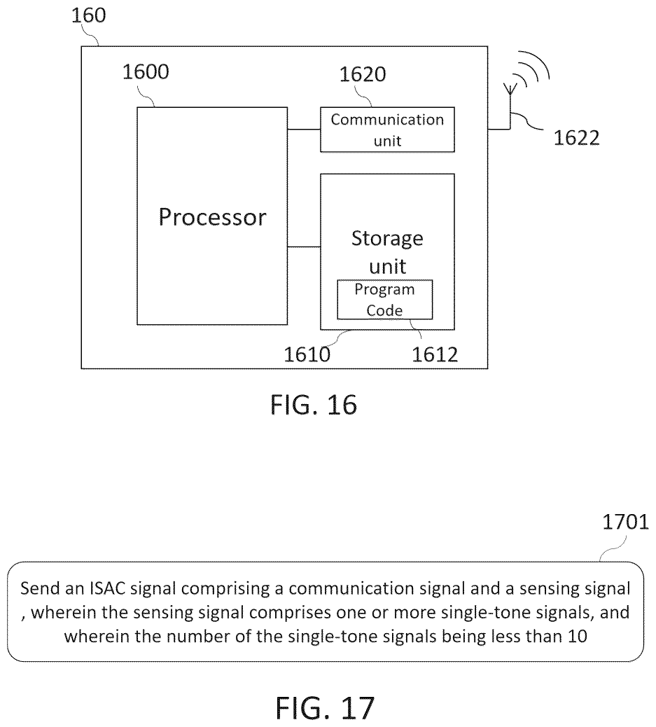

FIG. 16 relates to a schematic diagram of a wireless network node 160 according to an embodiment of the present disclosure. The wireless network node 160 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 160 may comprise (perform) at least one network function such as an access and mobility management function (AMF), a session management function (SMF), a user place function (UPF), a policy control function (PCF), an application function (AF), etc. The wireless network node 160 may include a processor 1600 such as a microprocessor or ASIC, a storage unit 1610 and a communication unit 1620. The storage unit 1610 may be any data storage device that stores a program code 1612, which is accessed and executed by the processor 1600. Examples of the storage unit 1612 include but are not limited to a SIM, ROM, flash memory, RAM, hard-disk, and optical data storage device. The communication unit 1620 may be a transceiver and is used to transmit and receive signals (e.g. messages or packets) according to processing results of the processor 1600. In an example, the communication unit 1620 transmits and receives the signals via at least one antenna 1622 shown in FIG. 16.

In an embodiment, the storage unit 1610 and the program code 1612 may be omitted. The processor 1600 may include a storage unit with stored program code.

The processor 1600 may implement any steps described in exemplified embodiments on the wireless network node 160, e.g., via executing the program code 1612.

The communication unit 1620 may be a transceiver. The communication unit 1620 may as an alternative or in addition be combining a transmitting unit and a receiving unit configured to transmit and to receive, respectively, signals to and from a wireless terminal (e.g. a user equipment or another wireless network node).

FIG. 17 shows a flowchart of a method according to an embodiment of the present disclosure. The method shown in FIG. 17 may be used in or performed by a wireless communication and sensing node (e.g. BS or UE) and comprises the following step:

Step 1701: Send an ISAC signal comprising a communication signal and a sensing signal, wherein the sensing signal comprises one or more single-tone signals, and wherein the number of the single-tone signals being less than 10.

In FIG. 17, the wireless communication and sensing node sends/transmits an ISAC signal comprising a communication signal and a sensing signal. In this embodiment, the sensing signal comprises one or more single-tine signals. In addition, the number of the single tone signals may be less than 10.

In an embodiment, the sensing signal consists of one single-tone signal. That is, the sensing signal may comprise only one single-tone signal.

In an embodiment, the time spacing between the first and last time-domain position of the one or more single-tone signals is larger than 90% of a total time duration of the ISAC signal.

In an embodiment, the one or more single-tone signals have a duty cycle within 0% and 100%. That is each single-tone signal may have arbitrary duty cycle.

In an embodiment, the one or more single-tone signals are periodic or non-periodic.

In an embodiment, the one or more single-tone signals are continuous or discontinuous.

In an embodiment, the ISAC signal comprises one or more guard bands between the one or more single-tone signals and the communication signal.

In an embodiment, the ISAC signal is carried on a plurality of sub-carriers, and one of the one or more single-tone signals is carried on one of the sub-carriers with the highest or lowest frequency band.

In an embodiment, the sensing signal is used as a reference signal of the communications signal.

In an embodiment, the wireless communication and sensing node may receive (an echo signal corresponding to) the sensing signal in the ISAC signal sent by the wireless communication and sensing node. The wireless communication and sensing node may extracts/determines sensing information (of a target) from/based on the received (echo signal corresponding to the) sensing signal. For example, the wireless communication and sensing node extracts/determines the sensing information based on a wireless channel/path corresponding to the received (echo signal corresponding to the) sensing signal.

In an embodiment, the one or more single-tone signals in difference periods have difference frequencies (see FIG. 5).

In an embodiment, the sensing signal in the ISAC signal is sent to another wireless communication and sensing node.

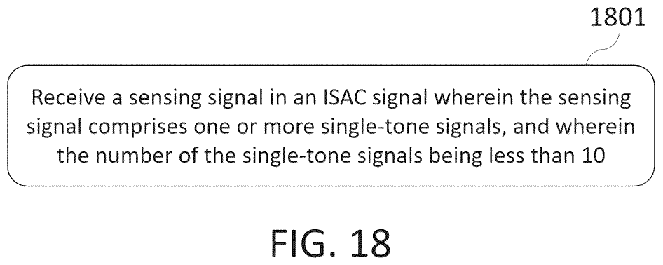

FIG. 18 shows a flowchart of a method according to an embodiment of the present disclosure. The method shown in FIG. 18 may be used in or performed by a wireless communication and sensing node and comprises the following steps:

Step 1801: Receive a sensing signal in an ISAC signal, wherein the sensing signal comprises one or more single-tone signals, and wherein the number of the single-tone signals being less than 10.

In this embodiment, the wireless communication and sensing node receives (an echo signal corresponding to) a sensing signal of an ISAC signal. Based on (the echo signal corresponding to) the sensing signal, the wireless communication and sensing node is able to determine sensing information (of a target/object). For example, the wireless communication and sensing node extracts/determines the sensing information based on a wireless channel/path corresponding to (the echo signal corresponding to) the sensing signal.

In an embodiment, the sensing signal consists of one single-tone signal. That is, the sensing signal may comprise only one single-tone signal.

In an embodiment, the time spacing between the first and last time-domain position of the one or more single-tone signals is larger than 90% of a total time duration of the ISAC signal.

In an embodiment, the one or more single-tone signals have a duty cycle within 0% and 100%. That is each single-tone signal may have arbitrary duty cycle.

In an embodiment, the one or more single-tone signals are periodic or non-periodic.

In an embodiment, the one or more single-tone signals are continuous or discontinuous.

In an embodiment, the ISAC signal comprises one or more guard bands between the one or more single-tone signals and the communication signal.

In an embodiment, the ISAC signal is carried on a plurality of sub-carriers, and one of the one or more single-tone signals is carried on one of the sub-carriers with the highest or lowest frequency band.

In an embodiment, the wireless communication and sensing node uses the sensing signal as a reference signal of a communication signal of the ISAC signal.

In an embodiment, the ISAC signal is sent by the wireless communication and sensing node itself (i.e. monostatic sensing).

In an embodiment, the ISAC signal is received from another wireless communication and sensing node (i.e. bistatic sensing). Note that a multi-static sensing (mode) can be seen as multiple pairs of bistatic sensing.

In an embodiment, the one or more single-tone signals in difference periods have difference frequencies (see FIG. 5).

The present disclosure also relates to the following. One node sends an ISAC signal, and the sensing signal in the ISAC signal is a combination of T single-tone signals, where 1≤T<10. The sensing signal in the ISAC signal is a single-tone signal. The time spacing between the first and last time-domain position of the single-tone signal is larger than 90% of the total time duration of the ISAC signal. The single-tone signal has an arbitrary duty cycle. The time-domain positions of the single-tone signal in the ISAC signal is periodic or non-periodic. The phase of single-tone signal is continuous or discontinuous. The guard band is inserted between the sensing signal and the communications signal. The frequency of single-tone signal can be different in different time periods. The sensing signal is used as the reference signal of the communications signal. One node receives the sensing signal and/or the communications signal in an ISAC signal, and the sensing signal in the ISAC signal is a combination of T single-tone signals, where 1≤T<10. The ISAC signal is used in the sensing modes including monostatic, bistatic, and multi-static. Different cells simultaneously sense the same target using the same or different sensing modes including monostatic, bistatic, and multi-static.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication and sensing method, comprising:
sending, by a wireless communication and sensing node, an integrated sensing and communication, ISAC, signal comprising a communication signal and a sensing signal, wherein the sensing signal comprises one or more single-tone signals, and wherein the number of the single-tone signals being less than 10.

2. The wireless communication and sensing method of claim 1, wherein the sensing signal consists of one single-tone signal.

3. The wireless communication and sensing method of claim 1, wherein the time spacing between the first and last time-domain position of the one or more single-tone signals is larger than 90% of a total time duration of the ISAC signal.

4. The wireless communication and sensing method of claim 1, wherein the one or more single-tone signals have a duty cycle within 0% and 100%.

5. The wireless communication and sensing method of claim 1, wherein the one or more single-tone signals are periodic or non-periodic.

6. The wireless communication and sensing method of claim 1, wherein the one or more single-tone signals are continuous or discontinuous.

7. The wireless communication and sensing method of claim 1, wherein the ISAC signal comprises one or more guard bands between the one or more single-tone signals and the communication signal.

8. The wireless communication and sensing method of claim 7, wherein the ISAC signal is carried on a plurality of sub-carriers, and one of the one or more single-tone signals is carried on one of the sub-carriers with the highest or lowest frequency band.

9. The wireless communication and sensing method of claim 1, wherein the sensing signal is used as a reference signal of the communications signal.

10. The wireless communication and sensing method of claim 1, further comprising:
receiving, by the wireless communication and sensing node, the sensing signal in the ISAC signal sent by the wireless communication and sensing node, and
determining, by the wireless communication and sensing node, sensing information based on the sensing signal.

11. The wireless communication and sensing method of claim 1, wherein the one or more single-tone signals in difference periods have difference frequencies.

12. The wireless communication and sensing method of claim 1, wherein the sensing signal in the ISAC signal is sent to another wireless communication and sensing node.

13. A wireless communication and sensing method comprising:
receiving, by a wireless communication and sensing node, a sensing signal in an integrated sensing and communication, ISAC, signal, wherein the sensing signal comprises one or more single-tone signals, and wherein the number of the single-tone signals being less than 10, and determining, by the wireless communication and sensing node, sensing information based on the sensing signal.

14. The wireless communication and sensing method of claim 13, wherein the sensing signal consists of one single-tone signal.

15. The wireless communication and sensing method of claim 13, wherein the time spacing between the first and last time-domain position of the one or more single-tone signals is larger than 90% of a total time duration of the ISAC signal.

16. The wireless communication and sensing method of claim 13, wherein the one or more single-tone signals have a duty cycle within 0% and 100%.

17. The wireless communication and sensing method of claim 13, wherein the one or more single-tone signals are periodic or non-periodic.

18. The wireless communication and sensing method of claim 13, wherein the one or more single-tone signals are continuous or discontinuous.

19. The wireless communication and sensing method of claim 13, wherein the ISAC signal comprises one or more guard bands between the one or more single-tone signals and a communication signal of the ISAC signal.

20. A wireless communication and sensing node, comprising:
a communication unit, configured to send an integrated sensing and communication, ISAC, signal comprising a communication signal and a sensing signal, wherein the sensing signal comprises one or more single-tone signals, and wherein the number of the single-tone signals being less than 10.
